(19) United States
(12) Patent Application Publication
(10) Pub. No.: US 2024/0157388 A1
(43) Pub. Date: May 16, 2024

(54) Internal Spray Gun Automatic Cleaning System

(71) Applicants: Kevin Gillest, Frasier, CO (US); Michael Calahan, Arvada, CO (US); Richard Lord, Westminster, CO (US); Todd Hoffman, Boulder, CO (US)

(72) Inventors: Kevin Gillest, Frasier, CO (US); Michael Calahan, Arvada, CO (US); Richard Lord, Westminster, CO (US); Todd Hoffman, Boulder, CO (US)

(21) Appl. No.: 18/055,832

(22) Filed: Nov. 15, 2022

(51) Int. Cl. B05B 15/522; B05B 13/06

(52) U.S. Cl. CPC B05B 15/522; B05B 13/0627

(57) ABSTRACT

An internal coating spray machine for cans or containers having spray gun(s) with nozzle(s) which may be automatically cleaned. Each spray gun has a clamp bracket which carries an actuator carrying a cleaning brush. When the actuator is actuated, it carries the brush from a first location (out of the way) to a second location in which the brush moves across the nozzle, cleaning it. The IC machine HMI (human-machine interface) may have a manually actuated control, for example, a button or soft button, which pauses can spraying and carries out a cleaning cycle. It may also use the low infeed sensor of the IC spray machine to detect when cans will be momentarily delayed coming in, and automatically clean during that small hiatus. A timer automatically initiates a cleaning cycle if one has not otherwise happened in a given time Xₜ.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but reserves all copyright rights whatsoever. 37 CFR 1.71(d).

### FIELD OF THE INVENTION

This invention relates generally to internal can coating machinery used during the manufacturing of cans, and specifically to a device for cleaning of internal can coating spray guns used in the can manufacturing process.

### STATEMENT REGARDING FEDERALLY FUNDED RESEARCH

This invention was not made under contract with an agency of the US Government, nor by any agency of the US Government.

### BACKGROUND OF THE INVENTION

The usual method of coating cylindrical bodies, such as steel and aluminum cans, uses spray guns which are fed a pressurized fluid and eject it through a nozzle in a spray of extremely fine droplets.

The spray gun is within an IC spray machine (IC refers to internal can coating). Cans are generally fed into the machine on a star wheel which rotates until an individual can is properly oriented and positioned in reference to a spray gun, then the spray gun is fired to spray the coating into the can interior. This process can be repeated hundreds of times per minute as the production line operates.

However, working with volatile liquids, especially ejecting them over and over again, results in various issues: the coating material gets into the ambient air, or builds up on the nozzle in the form of a “pigtail” like a small stalactite. The coating material may also simply build up on the exterior of the nozzle. Regardless of the form taken, the coating material fouls the nozzle, resulting in improper coating application. For this reason, the production run may be frequently interrupted or discontinued while the operators clean or change the gun nozzles.

Attempts have been made to address this issue, for example, U.S. Pat. No. 5,344,073, dated Sep. 6, 1994, in the name of Waryu et al. In that PRIOR ART patent, a second spray gun and nozzle are employed to spray the first spray gun and nozzle with a cleaning solution. There are fairly obvious disadvantages to this method: it requires a second gun, not for providing better coating of cans but simply to clean the first gun, it requires a stable supply of cleaning solution, results in increased costs and so forth.

Another attempt is seen in U.S. Pat. No. 6,544,336 dated Apr. 8, 2003 in the name of Lopes. In that PRIOR ART patent, a suction head is rotated onto the nozzle and suction is applied to help such the nozzle clean: the head has a vacuum conduit and presumably carries away the fouling materials via the vacuum conduit to some disposal receptacle.

It would be preferable to provide an inexpensive method of cleaning spray gun nozzles without using consumables such as cleaning fluid, which may cause environmental problems.

It would further be preferable to provide a method of cleaning spray gun nozzles without resorting to use of vacuum, vacuum seals, etc.

It would yet further be preferable to provide a method of cleaning spray gun nozzles during momentary down times when the IC spray machine is not operating for a few seconds.

### SUMMARY OF THE INVENTION

### General Summary

The present invention teaches an IC machine having spray guns with nozzles which may be automatically cleaned without manual intervention. Each spray gun has a clamp bracket which carries an actuator (electrical or pneumatic) which in turn carries on its shaft a cleaning brush. When the actuator is actuated it rotates its shaft, carrying the brush from a first location (out of the way of the spray gun's normal operation) to a second location in which the brush moves across the nozzle, cleaning it. When actuation is removed, the actuator springs back, carrying the brush back out of the way. A single cycle might be only 0.25 second or less, allowing a complete cleaning cycle to have multiple such cycles. The IC machine HMI (human-machine interface) may have a manually actuated control, for example, a button or soft button, which pauses can spraying and carries out a cleaning cycle. It may also use the low infeed sensor of the IC machine to detect when cans will be momentarily delayed coming in, and automatically clean during that small hiatus. Finally, it may have a timer which allows the machine to know when a certain time limit has passed without either low infeed or manual initiation of the cleaning cycle, in which case the machine automatically initiates a cleaning cycle.

In alternative embodiments, any of these methods of initiation may be omitted or supplemented.

### Summary in Reference to Claims

It is therefore another aspect, advantage, objective and embodiment of the invention, in addition to those discussed previously, to provide a can spray machine with cleaning mechanism comprising:
a spray gun having a nozzle at a first end;
a bracket mounted to the spray gun whereby the bracket moves with the spray gun;
an actuator mounted on the bracket whereby the actuator moves with the spray gun, the actuator having at least first and second modes: an actuated mode and an unactuated mode;
an actuator shaft projecting from the actuator, the actuator shaft remaining in a first angular rotation position when the actuator is in the unactuated mode but rotating to a second angular rotation position when the actuator is in the actuated mode, the actuator shaft returning to the first angular rotation position when the actuator returns to the unactuated mode;
a nozzle cleaning brush mounted to the actuator shaft whereby the nozzle cleaning brush remains in a first location when the actuator shaft is in the first angular rotation position, but the nozzle cleaning brush moving to a second location when the actuator shaft is in the second angular rotation position, the nozzle cleaning brush returning to the first location when the actuator shaft returns to the first angular rotation position;
the nozzle cleaning brush sweeping across the nozzle during the moving of the nozzle cleaning brush between the first and second locations;
an exhaust box having an exhaust box entrance disposed proximate to the second location, the exhaust box having a negative pressure which tends to such loose material from the second location into the exhaust box.

It is therefore another aspect, advantage, objective and embodiment of the invention, in addition to those discussed previously, to provide a can spray machine with cleaning mechanism wherein the nozzle is in the second location, and the nozzle cleaning brush is disposed on the nozzle when the nozzle is in the second location.

It is therefore another aspect, advantage, objective and embodiment of the invention, in addition to those discussed previously, to provide a can spray machine with cleaning mechanism wherein the nozzle is in a third location, the third location disposed intermediate to the first and second locations such that the nozzle cleaning brush sweeps across the nozzle a first time during the moving of the nozzle cleaning brush from the first location to the second location, and a second time during the moving of the nozzle cleaning brush from the second location to the first location.

It is therefore another aspect, advantage, objective and embodiment of the invention, in addition to those discussed previously, to provide a can spray machine with cleaning mechanism wherein the brush comprises:
a brush arm having first and second ends, the first end mounted on the actuator shaft, the second end having projecting therefrom a resilient cleaning head.

It is therefore another aspect, advantage, objective and embodiment of the invention, in addition to those discussed previously, to provide a can spray machine with cleaning mechanism wherein the actuator is pneumatically operated.

It is therefore another aspect, advantage, objective and embodiment of the invention, in addition to those discussed previously, to provide a can spray machine with cleaning mechanism wherein the actuator is electrically operated.

It is therefore another aspect, advantage, objective and embodiment of the invention, in addition to those discussed previously, to provide a can spray machine with cleaning mechanism wherein the first and second angular rotation positions are at least 90 degrees apart.

It is therefore another aspect, advantage, objective and embodiment of the invention, in addition to those discussed previously, to provide a can spray machine with cleaning mechanism further comprising:
a second spray gun having a second nozzle at a second end, the second spray gun mounted non-co-axially to the first spray gun;
a second bracket mounted to the second spray gun whereby the second bracket moves with the second spray gun;
a second actuator mounted on the second bracket whereby the second actuator moves with the second spray gun, the second actuator also having at least the first and second modes: the actuated mode and the unactuated mode;
a second actuator shaft projecting from the second actuator, the second actuator shaft remaining in the first angular rotation position when the second actuator is in the unactuated mode but rotating to the second angular rotation position when the second actuator is in the actuated mode, the second actuator shaft returning to the first angular rotation position when the actuator returns to the unactuated mode;
a second nozzle cleaning brush mounted to the second actuator shaft whereby the second nozzle cleaning brush remains in a THIRD location when the second actuator shaft is in the first angular rotation position, but the second nozzle cleaning brush moving to a FOURTH location when the second actuator shaft is in the second angular rotation position, the second nozzle cleaning brush returning to the THIRD location when the second actuator shaft returns to the first angular rotation position;
the second nozzle cleaning brush sweeping across the second nozzle during the moving of the second nozzle cleaning brush between the THIRD and FOURTH locations.

It is therefore another aspect, advantage, objective and embodiment of the invention, in addition to those discussed previously, to provide a can spray machine with cleaning mechanism whereby when the first and second actuators are actuated, both spray guns receive a nozzle cleaning.

It is therefore another aspect, advantage, objective and embodiment of the invention, in addition to those discussed previously, to provide a can spray machine with cleaning mechanism wherein the first and second actuators may be actuated multiple times per second.

It is therefore another aspect, advantage, objective and embodiment of the invention, in addition to those discussed previously, to provide a can spray machine with cleaning mechanism further comprising a low infeed condition sensor, the low infeed condition sensor operative to detect a low infeed condition and then actuate the first and second actuators during the low infeed condition.

It is therefore another aspect, advantage, objective and embodiment of the invention, in addition to those discussed previously, to provide a can spray machine with cleaning mechanism further comprising: a human-machine interface, the human-machine interface having a control function, the control function operative when manually actuated to in turn actuate the first and second actuators.

It is therefore another aspect, advantage, objective and embodiment of the invention, in addition to those discussed previously, to provide a can spray machine with cleaning mechanism further comprising: a timer, the timer operative to detect the passage of a first time Xₜ since a previous actuation of the first and second actuators, and when first time Xₜ is exceeded, pause a can spraying operation and actuate the first and second actuators;
the human-machine interface having a control function operative to set Xₜ.

It is therefore yet another aspect, advantage, objective and embodiment of the invention, in addition to those discussed previously, to provide a can spray machine with cleaning mechanism comprising:
a spray gun having a nozzle at a first end;
a bracket mounted to the spray gun, the bracket moving with the spray gun;
a motor mounted on the bracket whereby the motor moves with the spray gun, the motor having at least first and second modes: an actuated mode and an unactuated mode;
a motor shaft projecting from the motor, the motor shaft remaining in a first angular rotation position when the motor is in the unactuated mode but rotating to a second angular rotation position when the motor is in the actuated mode, the motor shaft rotating 360 degrees and returning to the first angular rotation position when the motor returns to the unactuated mode;
a nozzle cleaning brush mounted to the motor shaft whereby the nozzle cleaning brush remains in a first location when the motor shaft is in the first angular rotation position, but the nozzle cleaning brush moving to a second location when the motor shaft is in the second angular rotation position, the nozzle cleaning brush returning to the first location when the motor shaft returns to the first angular rotation position;
the nozzle cleaning brush sweeping across the nozzle during the moving of the nozzle cleaning brush between the first and second locations.

It is therefore another aspect, advantage, objective and embodiment of the invention, in addition to those discussed previously, to provide a retrofit kit for a can spray machine, the can spray machine having a spray gun having a first end having a nozzle, the retrofit kit comprising:
a bracket dimensioned and configured to mount to such spray gun and once mounted moving therewith;
an actuator dimensioned and configured to mount to the bracket and once mounted moving therewith, the actuator having first and second modes, a first unactuated mode and a second actuated mode;
an actuator shaft projecting from the actuator, the actuator shaft remaining in a first angular rotation position when the actuator is in the unactuated mode but rotating to a second angular rotation position when the actuator is in the actuated mode, the actuator shaft returning to the first angular rotation position when the actuator returns to the unactuated mode;
a nozzle cleaning brush dimensioned and configured to mount to the actuator shaft whereby the nozzle cleaning brush remains in a first location when the actuator shaft is in the first angular rotation position, but the nozzle cleaning brush moving to a second location when the actuator shaft is in the second angular rotation position, the nozzle cleaning brush returning to the first location when the actuator shaft returns to the first angular rotation position;
the nozzle cleaning brush sweeping across such nozzle during the moving of the nozzle cleaning brush between the first and second locations.

It is therefore another aspect, advantage, objective and embodiment of the invention, in addition to those discussed previously, to provide a retrofit kit wherein the brush comprises:
a brush arm having first and second ends, the first end mounted on the actuator shaft, the second end having projecting therefrom a resilient cleaning head.

It is therefore another aspect, advantage, objective and embodiment of the invention, in addition to those discussed previously, to provide a retrofit kit wherein the actuator is pneumatically operated.

It is therefore another aspect, advantage, objective and embodiment of the invention, in addition to those discussed previously, to provide a retrofit kit wherein the actuator is electrically operated.

### BRIEF DESCRIPTION OF THE DRAWINGS

FIG. 1 is an elevated rear orthogonal view of an IC spray machine according to the present invention.

FIG. 2 is a close-up view of the operative portion of FIG. 1, (from close up section “A”) showing a spray gun, gun mount, and cleaning apparatus.

FIG. 3 is a front elevational orthogonal view of the operative part of the IC spray machine, including both guns, both mounts, both nozzle cleaning brushes and actuators, and more.

FIG. 4 is a front elevational orthogonal view of a spray gun with the cleaning brush in the first location (allowing the spray gun to operate), the actuator shaft in the first angular rotation position and the actuator in the unactuated mode.

FIG. 5 is a front elevational orthogonal view of a spray gun with the cleaning brush in the second location (cleaning the nozzle), the actuator shaft in the second angular rotation position and the actuator in the actuated mode.

FIG. 6 is a summary flow chart of the operation of the invention.

### INDEX TO REFERENCE NUMERALS

IC Spray Machine 100
Spray gun 102
Spray gun 104
Gun mount 106
Gun mount 108
Nozzle 110
Gun end 114
Gun end 116
Bracket/clamp 118
Bracket/clamp 120
Actuator 122
Actuator 124
Actuator shaft 126
Actuator shaft 128
First angular rotation position 130
Second angular rotation position 134
Nozzle cleaning brush 138
Nozzle cleaning brush 140
First location 142
Second location 144
Third location 146
Fourth location 148
Brush arm 150
Brush arm first end 154
Resilient cleaning head 158
Low infeed condition sensor 160
Human-machine interface 162
Exhaust box 164
Exhaust box entrance 166
Counter 196
Can number Ct 198
Low infeed condition 200
Manual control function 202
Timer 204
Xt 206
Actuation 208
Y times 210

### DETAILED DESCRIPTION

### Glossary

As used herein, an actuator is any pneumatic or electrical device which, when actuated, causes a shaft to rotate. This may include at least the following: servo motors, stepper motors, electrical motors having defined stopping positions, and so forth. Actuators are considered the lowest cost and most reliable option.

As used herein a bracket may refer to anything which clamps onto a spray gun or spray gun mount or other part of an IC spray machine and holds an actuator, directly or indirectly, clamped to the spray gun, in parallel, co-axially, or in any other arrangement which causes the actuator to move with the spray gun when the spray gun moves.

IC in this application refers to a spray machine being used to internally coat cans, however, the device is not so limited. The IC spray gun is part of an IC spray machine (IC refers to internal can coating).

### End Glossary

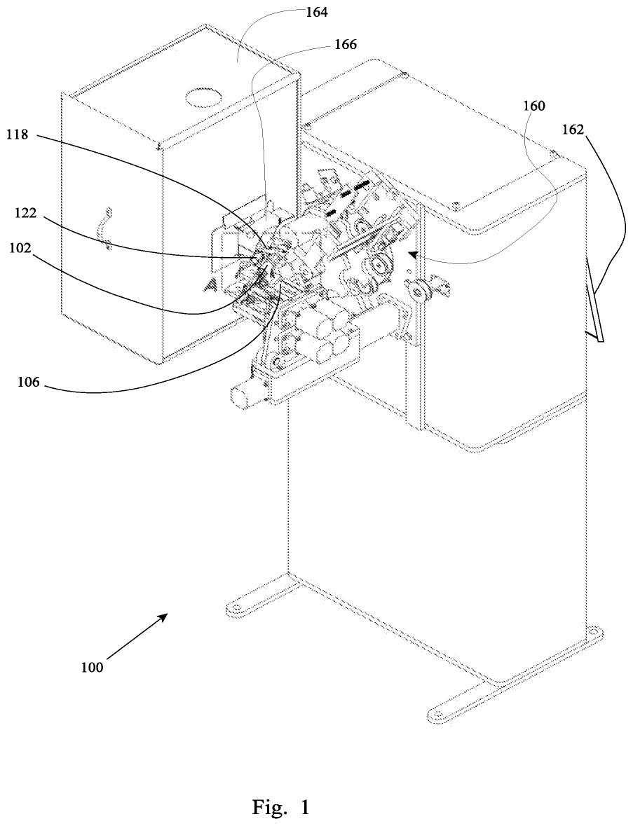

FIG. 1 is an elevated rear orthogonal view of an IC spray machine according to the present invention. The IC spray machine 100 has a cabinet or other housing, this is helpful, especially the hood for collecting coating material and preventing it from escaping or covering the machine. IC Spray Machine 100 also has a human-machine interface 162 which may be a touch screen, keypad and screen, array of hard buttons or the like.

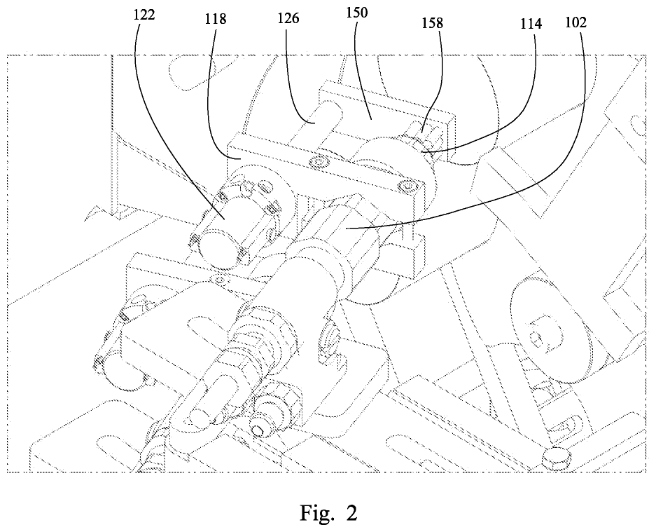

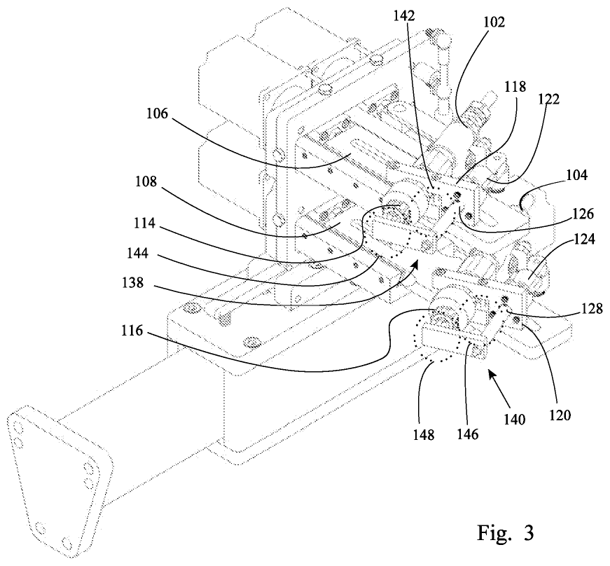

Spray gun 102 (and spray gun 104 beneath it, more easily seen in FIGS. 2 and 3). Gun mount 106 carries the spray gun 102 thereupon. Referring again to FIGS. 2 and 3, it may be seen that gun mount 108 carries gun 104.

In this design, there is no gun for carrying cleaning solution. Both guns 102 and 104 are used to coat the interior of cans carried by the starwheel, providing not just more effective coating than a single gun but also faster operations. (The starwheel and infeed, un-numbered, may be seen somewhat obscured by the gun mounts and guns. The infeed has a sensor 160 which detects a low infeed condition (as seen in FIG. 1 in which there is a temporary lack of cans on the infeed.)

Actuator 122 and bracket clamp 118 may also be seen.

Exhaust box 164 is designed to use negative air pressure to remove vapor, spray particles, overspray and so forth, for example for clean disposal in order to avoid environmental problems. It may be seen that the exhaust box entrance 166 located (disposed) closely adjacent to the spray gun nozzle and the brush. When the nozzle is cleaned, the pigtail or other detritus is sucked into the entrance 166 and thus removed. Note that the resilient (rubbery, flexible) material of the brush 158 does not tend to collect material clinging to it, including the dried spray and other foreign matter from the nozzle. Since it does not cling, it falls free and thus into the ambit if the negative pressure and is removed via the exhaust box 164.

FIG. 2 is a close up view of the operative portion of FIG. 1, showing a spray gun (the top gun 102), its bracket 118, and cleaning apparatus like brush 138 parts.

Nozzle 110 is on gun end 114 but facing away and thus not visible in this drawing, in addition, it is obscured by the brush arm 150 with the brush's resilient cleaning head 158 shown actually on the nozzle/gun end 114, cleaning them.

From this angle, actuator 122 on the bracket 118 is clearly visible, with actuator shaft 126 visible rotatably passing through the bracket clamp 118. In this embodiment the actuator is mounted co-axial to the spray gun axis, but this is merely the best mode presently contemplated and preferred embodiment, in practice the actuator 118 may be mounted in any configuration which allows it to move with the gun 102 and brush the resilient cleaning head 158 across the gun end 114.

The brush 150 has an elongated body which is rotated by the actuator shaft 126: in this drawing number 2, the actuator is shown in the actuated mode, with the resilient cleaning head 158 actually cleaning the gun end 114.

FIG. 3 is a front elevational orthogonal view of the operative part of the IC spray machine, including both guns, both mounts, both nozzle cleaning brushes 138/140 and actuators, and more.

Fun 104 can be seen beneath gun 102: to reiterate, gun 104 is spraying coating onto the cans, like gun 102. The second gun does not spray cleaning solution.

Gun end 116 is shown. Both gun ends 114 and 116 are being cleaned: they may be cleaned at different times or the same time, either way might be more efficient. For example, if a can is in front of gun 104, it might not be cleaned when gun 102 is, but if neither has a can in front of it, both might be being cleaned. In other embodiments, the nozzles/gun ends 114/116 might be cleaned regardless of whether cans are in front of them or not.

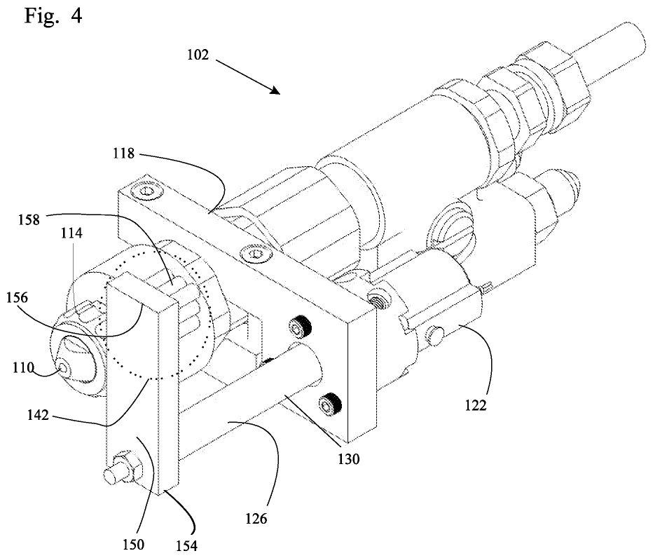

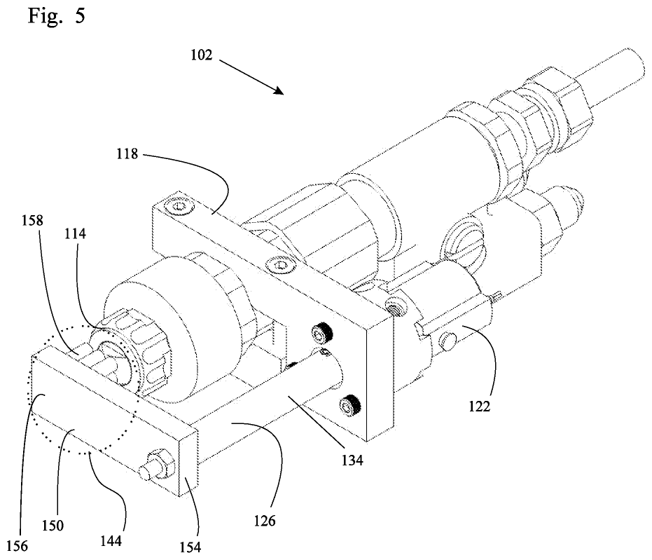

Bracket/clamp 118 and bracket/clamp 120 are clearly seen carrying their respective actuators 122 and 124, both of which are in the actuated position with the actuator shafts 126 and 128 rotated out of the first (resting) angular rotation position 130 (FIG. 4), and rotated into the second angular rotation position 134 (actuated and brushing), which is seen in FIG. 3, FIG. 5, etc. When the shafts 126/128 are rotated, the move the nozzle cleaning brushes 138 and 140 out of the first location 142 and third location 146 (their resting locations) and into the second location 144 and the fourth location 148. In these respective positions, the brush arms 150 rotate (more than 90 degrees in preferred embodiments, and more preferably 180 degrees, and even 360 degrees or multiple complete circles) in front of the nozzles for the cleaning.

FIG. 4 is a front elevational orthogonal view of a spray gun with the cleaning brush in the first location (allowing the spray gun to operate), the actuator shaft in the first angular rotation position 130 and the actuator in the unactuated mode.

Brush arm first end 154 is attached to the actuator shaft 126 so that the rotation of the shaft 126 also rotates the arm 150.

Resilient cleaning head 158 may be a nylon bristle brush, polymer cylinders, or other similar semi-flexible bodies. Finally, nozzle 110 may be seen.

Careful comparison of FIG. 4 to FIG. 5 (a spray gun with the cleaning brush in the second location (cleaning the nozzle) and the actuator shaft in the second angular rotation position 132 and the actuator in the actuated mode) is now useful.

In FIG. 5 the same gun 102 is seen with the actuator 122 operating, which has rotated the shaft 126 and rotated the cleaning brush 130 (about the attached end 154) so that the brush arm 150, specifically the moving end 156 carries the resilient cleaning head 158 across the gun end 114, nozzle 110, and any coating which is fouling the nozzle 110 and cleaning end 114, such as a blockage, a pigtail, etc.

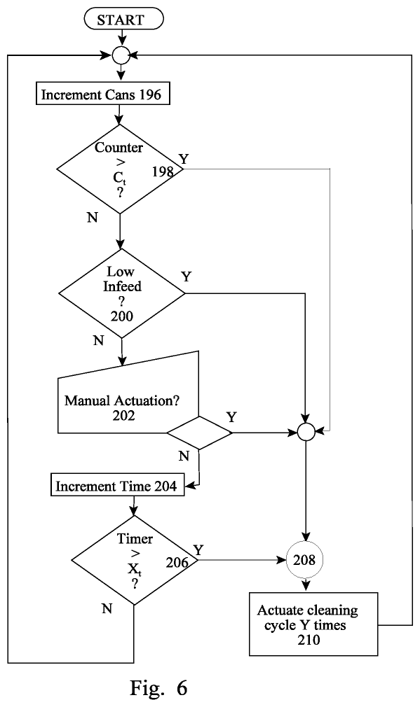

FIG. 6 is a summary flow chart of the operation of the invention. In actual production, the process is much more complicated but this outlines one possible ordering of control logic for operation. Obviously, the order of operations (priority) for various causes of initiation may vary, or some methods of initiation may be omitted or others used in addition to these.

The process begins when the IC spray machine begins production: a can counter 196 is incremented, when the counter is greater than a can limit (can number) 198, the system is triggered.

In addition, if a low infeed condition 200 is detected by the low infeed condition sensor 160 then the machine initiates the cleaning cycle, which may be one or more actuations 208 and thus one or more brushings of the nozzle. If the low infeed condition is not sensed (the normal condition if production is proceeding smoothly), then the machine checks for a manually initiated cleaning cycle via manual control function 202, and if that condition is found true initiates the cleaning cycle. Finally, if there is neither a can number limit exceeded, nor a low infeed condition nor a manual initiation then the timer increments 204, checks if too much time has passed (by comparison with a time limit Xₜ 206), and carries out actuation 208 if the time is sufficient. The number of times Y (the number of actuations) which a single cleaning cycle actuates, and the time limit Xₜ before cleaning is actuated anyway, may both be set by the human-machine interface functions. Note that the human-machine interface 162 need not be the control panel seen in FIG. 1 but may instead be done by remote control, for example, an app on a mobile device such as a tablet, or a computer, etc. The control logic (a PLC, CPU or equivalent) may thus be accessible in any convenient manner.

Note that when the low infeed condition is sensed, there is a pause in production due to the low infeed and the machine opportunistically cleans the nozzles while no production is occurring. On the other hand, the manual actuation, or timed actuation, would of course result in a quite brief pause in can coating process while cleaning occurs. In other embodiments, the timing of the cleaning may be synchronized to occur in between individual cans, eliminating this pause.

In embodiments, the motor may provide rotation only in one direction and after passing the brush over the nozzle, it may continue rotating until 360 degrees rotation is achieved and the brush returns to the first position. This may advantageously allow numerous passes over the nozzle in a short period of time. It may of course rotate less than 360 degrees, more than 360, multiples of 360 and so forth, but with the overall ability to continue being positioned to clean the nozzle by passing across it.

In one particularly favored embodiment at the present time, a retrofit kit mode may be employed. This would be preferrable as there is a large installed base of units without cleaning abilities in use in customer production facilities. The parts seen in the figures, in particular the bracket, actuator/motor, brush, arm, etc may all be dimensioned and configured to mechanically engage to known and installed spray guns. This mounting allows the retrofitted unit to rotate with the spray gun as normal.

When a brush is dirty from use, or at a set time, etc, the brushes may be removed and replaced with a clean brush.

The disclosure is provided to render practicable the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

Methods and components are described herein. However, methods and components similar or equivalent to those described herein can be also used to obtain variations of the present invention. The materials, articles, components, methods, and examples are illustrative only and not intended to be limiting.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any and all modifications or alternatives which might be predictable to a person having ordinary skill in the art.

Having illustrated and described the principles of the invention in exemplary embodiments, it should be apparent to those skilled in the art that the described examples are illustrative embodiments and can be modified in arrangement and detail without departing from such principles. Techniques from any of the examples can be incorporated into one or more of any of the other examples. It is intended that the specification and examples be considered as exemplary only, with a true scope and spirit of the invention being indicated by the following claims.

What is claimed is:

1. A can IC spray machine with cleaning mechanism comprising:
an spray gun having a nozzle at a first end;
a bracket mounted to the spray gun;
an actuator mounted on the bracket, the actuator having at least first and second modes:
an actuated mode and an unactuated mode;
an actuator shaft projecting from the actuator, the actuator shaft remaining in a first angular rotation position when the actuator is in the unactuated mode but rotating to a second angular rotation position when the actuator is in the actuated mode, the actuator shaft returning to the first angular rotation position when the actuator returns to the unactuated mode;
a nozzle cleaning brush mounted to the actuator shaft whereby the nozzle cleaning brush remains in a first location when the actuator shaft is in the first angular rotation position, but the nozzle cleaning brush moving to a second location when the actuator shaft is in the second angular rotation position, the nozzle cleaning brush returning to the first location when the actuator shaft returns to the first angular rotation position;
the nozzle cleaning brush sweeping across the nozzle during the moving of the nozzle cleaning brush between the first and second locations;
an exhaust box having an exhaust box entrance disposed proximate to the second location, the exhaust box having a negative pressure which tends to such loose material from the second location into the exhaust box.

2. The can IC spray machine with cleaning mechanism of claim 1, wherein the nozzle is in the second location, and the nozzle cleaning brush is disposed in the cleaning position on the nozzle when the nozzle is in the second location.

3. The can IC spray machine with cleaning mechanism of claim 1, wherein the nozzle is in a third location, the third location disposed intermediate to the first and second locations such that the nozzle cleaning brush sweeps across the nozzle a first time during the moving of the nozzle cleaning brush from the first location to the second location, and a second time during the moving of the nozzle cleaning brush from the second location to the first location.

4. The can IC spray machine with cleaning mechanism of claim 1, wherein the brush comprises:
a brush arm having first and second ends, the first end mounted on the actuator shaft, the second end having projecting therefrom a resilient cleaning head.

5. The can IC spray machine with cleaning mechanism of claim 4, wherein the actuator is pneumatically operated.

6. The can IC spray machine with cleaning mechanism of claim 4, wherein the actuator is electrically operated.

7. The can IC spray machine with cleaning mechanism of claim 5, wherein the first and second angular rotation positions are at least 90 degrees apart.

8. The can IC spray machine with cleaning mechanism of claim 7, further comprising:
a second spray gun having a second nozzle at a second end, the second spray gun mounted non-co-axially to the first spray gun;
a second bracket mounted to the second spray gun;
a second actuator mounted on the second bracket, the second actuator also having at least the first and second modes: the actuated mode and the unactuated mode;
a second actuator shaft projecting from the second actuator, the second actuator shaft remaining in the first angular rotation position when the second actuator is in the unactuated mode but rotating to the second angular rotation position when the second actuator is in the actuated mode, the second actuator shaft returning to the first angular rotation position when the actuator returns to the unactuated mode;
a second nozzle cleaning brush mounted to the second actuator shaft whereby the second nozzle cleaning brush remains in a third location when the second actuator shaft is in the first angular rotation position, but the second nozzle cleaning brush moving to a fourth location when the second actuator shaft is in the second angular rotation position, the second nozzle cleaning brush returning to the third location when the second actuator shaft returns to the first angular rotation position;
the second nozzle cleaning brush sweeping across the second nozzle during the moving of the second nozzle cleaning brush between the third and fourth locations.

9. The can IC spray machine with nozzle cleaning system of claim 8, whereby when the first and second actuators are actuated, both spray guns receive a nozzle cleaning.

10. The can IC spray machine with nozzle cleaning system of claim 9, wherein the first and second actuators may be actuated multiple times per second.

11. The can IC spray machine with nozzle cleaning system of claim of 10, further comprising a low infeed condition sensor, the low infeed condition sensor operative to detect a low infeed condition and then actuate the first and second actuators during the low infeed condition.

12. The can IC spray machine with nozzle cleaning system of claim 11, further comprising: a human-machine interface, the human-machine interface having a control function, the control function operative when manually actuated to in turn actuate the first and second actuators.

13. The can IC spray machine with nozzle cleaning system of claim of 12, further comprising: a timer, the timer operative to detect the passage of a first time Xₜ since a previous actuation of the first and second actuators, and when first time Xₜ is exceeded, pause a can spraying operation and actuate the first and second actuators;
the human-machine interface having a control function operative to set Xₜ.

14. A can IC spray machine with cleaning mechanism comprising:
a spray gun having a nozzle at a first end;
a bracket mounted to the spray gun;
a motor mounted on the bracket, the motor having at least first and second modes: an actuated mode and an unactuated mode;
a motor shaft projecting from the motor, the motor shaft remaining in a first angular rotation position when the motor is in the unactuated mode but rotating to a second angular rotation position when the motor is in the actuated mode, the motor shaft rotating 360 degrees and returning to the first angular rotation position when the motor returns to the unactuated mode;
a nozzle cleaning brush mounted to the motor shaft whereby the nozzle cleaning brush remains in a first location when the motor shaft is in the first angular rotation position, but the nozzle cleaning brush moving to a second location when the motor shaft is in the second angular rotation position, the nozzle cleaning brush returning to the first location when the motor shaft returns to the first angular rotation position;
the nozzle cleaning brush sweeping across the nozzle during the moving of the nozzle cleaning brush between the first and second locations.

15. A retrofit kit for a can IC spray machine, the can IC spray machine having an spray gun having a first end having a nozzle, the retrofit kit comprising:
a bracket dimensioned and configured to mount to such spray gun;
an actuator dimensioned and configured to mount to the bracket, the actuator having first and second modes, a first unactuated mode and a second actuated mode;
an actuator shaft projecting from the actuator, the actuator shaft remaining in a first angular rotation position when the actuator is in the unactuated mode but rotating to a second angular rotation position when the actuator is in the actuated mode, the actuator shaft returning to the first angular rotation position when the actuator returns to the unactuated mode;
a nozzle cleaning brush dimensioned and configured to mount to the actuator shaft whereby the nozzle cleaning brush remains in a first location when the actuator shaft is in the first angular rotation position, but the nozzle cleaning brush moving to a second location when the actuator shaft is in the second angular rotation position, the nozzle cleaning brush returning to the first location when the actuator shaft returns to the first angular rotation position;
the nozzle cleaning brush sweeping across such nozzle during the moving of the nozzle cleaning brush between the first and second locations.

16. The retrofit kit of claim 15, wherein the brush comprises:
a brush arm having first and second ends, the first end mounted on the actuator shaft, the second end having projecting therefrom a resilient cleaning head.

17. The retrofit kit of claim 16, wherein the actuator is pneumatically operated.

18. The retrofit kit of claim 17, wherein the actuator is electrically operated.
